(19) United States
(12) Patent Application Publication
(10) Pub. No.: US 2025/0060948 A1
(43) Pub. Date: Feb. 20, 2025

(54) COMPUTING PLATFORM AND SYSTEMS CONFIGURED TO ENHANCE INTERACTIONS WITH CHATBOT SYSTEMS

(71) Applicant: Lyno Sullivan, Billings, MT (US)

(72) Inventor: Lyno Sullivan, Billings, MT (US)

(21) Appl. No.: 18/798,217

(22) Filed: Aug. 8, 2024

Related U.S. Application Data
(60) Provisional application No. 63/564,921, filed on Mar. 13, 2024.
(60) Provisional application No. 63/609,607, filed on Dec. 13, 2023.
(60) Provisional application No. 63/545,461, filed on Oct. 24, 2023.
(60) Provisional application No. 63/533,463, filed on Aug. 18, 2023.

(51) Int. Cl. G06F 8/34

(52) U.S. Cl. CPC G06F 8/34

(57) ABSTRACT

Disclosed herein is a computing platform for providing enhanced interactivity with a chatbot system and other forms of artificial intelligence. The computing platform includes computer programming languages and systems thereof configured to interact with chatbots and chatbot systems. In some examples, the platform interacts, via at least one of the programming languages, with a large language model-based chatbot system—such as ChatGPT. In some examples, the platform includes the chatbot or the chatbot system. In some examples, the platform, via the programming language(s), interacts with a large language model-based chatbot system to input, record, organize, distribute, adapt, or perform creative works. The platform can also implement a money flow model (MFM) through at least one of the languages. Also, the platform can provide functions, via at least one of the languages, to interact with games and competitions where humans and artificial intelligence compete with and against each other.

### CROSS-REFERENCE TO RELATED APPLICATIONS

The present application claims the benefit of priority from (1) U.S. Provisional Patent Application No. 63/564,921, filed on Mar. 13, 2024, and entitled “CONVERGED HUMAN-AI TEAM COMPETITION AND METHODS AND SYSTEMS THEREOF”, (2) U.S. Provisional Patent Application No. 63/609,607, filed on Dec. 13, 2023, and entitled “COMPUTING SYSTEM FOR A MONEY FLOW MODEL”, (3) U.S. Provisional Patent Application No. 63/545,461, filed on Oct. 24, 2023, and entitled “COMPUTING SYSTEM THAT INTERACTS WITH CHATBOT SYSTEMS TO RECORD, ORGANIZE, ENHANCE, DISTRIBUTE, ADAPT, AND/OR PERFORM CREATIVE WORKS”, and (4) U.S. Provisional Patent Application No. 63/533,463, filed on Aug. 18, 2023, and entitled “COMPUTING SYSTEM THAT INTERACTS WITH CHATBOT SYSTEMS”, the entire disclosures of which applications are hereby incorporated herein by reference.

### TECHNICAL FIELD

The present disclosure relates to computing platforms and systems that include computer programming languages and systems thereof configured to interact with chatbots and chatbot systems.

### BACKGROUND

There is a lot of room for improvement in computing systems and platforms that interact with chatbot systems such as ChatGPT. A computing platform can be a system that includes software and the infrastructure in which the software is executed. For example, in a single computer system, the platform may include the computer's architecture, operating system (OS), and runtime libraries. These would be the example components of a platform or system that interacts with a chatbot system.

ChatGPT, which stands for Chat Generative Pre-trained Transformer, is a large language model-based chatbot developed by OpenAI, notable for enabling users to refine and steer a conversation towards a desired length, format, style, level of detail, and language used. Successive prompts and replies, known as prompt engineering, are considered at each conversation stage as a context. See Wikipedia. As mentioned, computing systems and platforms that interact with chatbot systems, such as ChatGPT, have much room for improvement.

### SUMMARY

Disclosed herein is a computing platform for providing enhanced interactivity with a chatbot system and other forms of artificial intelligence. The computing platform includes computer programming languages and systems thereof configured to interact with chatbots and chatbot systems. In some examples, the platform interacts, via at least one of the programming languages, with a large language model-based chatbot system—such as ChatGPT. In some examples, the platform includes the chatbot or the chatbot system. In some examples, the platform, via the programming language(s), interacts with a large language model-based chatbot system to input, record, organize, distribute, adapt, or perform creative works. The platform can also implement a money flow model (MFM) through at least one of the languages. Also, the platform can provide functions, via at least one of the languages, to interact with games and competitions where humans and artificial intelligence compete with and against each other.

Also, disclosed herein are systems including computer programming languages configured to interact with chatbots and chatbot systems. In general, the technologies described herein (including the platform and the computer programming languages and systems thereof) provide specific technical solutions to at least overcome the technical problems mentioned in the background section and other parts of the application as well as other technical problems not described herein but recognized by those skilled in the art, such as technical solutions to overcome technical problems in computing systems that interact with chatbot systems such as ChatGPT.

With respect to some embodiments, disclosed herein are methods including a computer programming language interacting with a chatbot or a system providing a chatbot as well as a non-transitory computer-readable storage medium for carrying out technical operations of the methods. The non-transitory computer-readable storage medium has tangibly stored thereon, or tangibly encoded thereon, computer-readable instructions that when executed by one or more devices (e.g., one or more personal computers or servers) cause at least one processor to perform a method including a computer programming language interacting with a chatbot or a system providing a chatbot.

With respect to some embodiments, a system is provided that includes a computer programming language configured to interact with a chatbot or a system providing a chatbot. And, with respect to some embodiments, a corresponding method is provided to be performed by at least one computing device. In some example embodiments, computer program code can be executed by at least one processor of one or more computing devices to implement functionality in accordance with at least some embodiments disclosed herein; and the computer program code being at least a part of or stored in a non-transitory computer-readable medium.

Specifically, in some embodiments, a system includes a computer programming language that is configured to interact with a chatbot. The system can also include the chatbot. The chatbot can include or be a part of a large language model-based chatbot system. The computer programming language can include functions configured to interact with the chatbot, via a prompt of the chatbot, to input, record, organize, distribute, adapt, and perform creative works. And, the functions can also be configured to generate and enhance parts of a creative work as well as organize, store, distribute, adapt, or perform the parts of the creative work. The computer programming language can also include a scripting language configured to interact with the chatbot via the prompt. The scripting language can also be configured to generate and enhance parts of a creative work as well as organize, store, distribute, adapt, or perform the parts of the creative work.

Also, in some embodiments, the programming language includes functions configured to normalize the parts of the creative work. Also, the programming language can also include functions configured to output respective normalized versions of the parts and store the parts in a database such that the parts are queryable. In some cases, the normalization of the parts includes limiting, via filters of a weighting system, bias of a group or an individual inputting or recording the creative work. Also, the normalization of the parts can occur prior to organizing, storing, or distributing the parts.

Further, in some embodiments, the programming language includes prompt-insertable functions configured to be inserted into the prompt of the chatbot and configured to generate and enhance parts of creative work as well as organize, store, distribute, adapt, and perform the parts of the creative work. The prompt-insertable functions can include pseudocode and pseudocode parameters configured to modulate instructions performed via the prompt-insertable functions. The pseudocode can be received by the chatbot to configure the chatbot to perform a process that corresponds to the function of the pseudocode. And, the elements of the pseudocode can be configured to facilitate the recording of stories, conversations, and other expressions and to add additional functionality beyond verbal content to make the content organizable, interactive, persistent, and applicable to functionality related to storage in a database or a blockchain. Also, elements of the pseudocode can be configured to track online session information and state information corresponding to the creative works.

Also, in some embodiments, the system further includes an editor configured to perform semantic editing of input received by the prompt of the chatbot, the editing of the input being based on rules of a knowledgebase of the system. Also, in some embodiments, the system further includes an MFM including an MFM engine configured to run steps of the MFM to reduce complexity and inconsistencies in monetary transactions occurring through or related to the chatbot or the system. The programming language can further include functions of the MFM configured to facilitate the monetary transactions, and the steps of the MFM can include steps for running the functions of the MFM. Also, the steps of the MFM can include running a linguistic analysis on one or more inputs of the monetary transactions.

Also, in some embodiments, the system includes a code tracking system configured to generate codes (such as QR codes) and assign the codes to end users of the system to control access and participation in social events provided by the system. The code tracking system can also be configured to track, via the respective codes, the interests of the end users, interactions between the end users and system, and outcomes from the social events such as outcomes associated with the end users. And, the code tracking system can also be configured to use the tracked interests, interactions, and outcomes or a derivative thereof to perform further actions such as providing corresponding feedback to the end users and generating various metrics on the tracked interests, interactions, and outcomes.

In some cases, the end users include attendees of the social events. The social events can include games and competitions in which the attendees participate in the games and competitions. Also, the code tracking system can be configured to track, via the respective codes, the interests of the attendees, interactions between the attendees and the system, and outcomes from the games and competitions. And, the code tracking system can be configured to use the tracked interests, interactions, and outcomes or a derivative thereof to perform further actions such as providing corresponding feedback to the attendees and generating various metrics on the tracked interests, interactions, and outcomes. Also, the system can further include interactive physical areas that include a user interface device configured to provide the chatbot as well as additional user interface devices including components configured to sense attributes or actions of the end users or interact with the end users to accompany functionality of the chatbot. And, the additional user interface devices can include biometrics devices and environmental conditions sensors.

Also, the system can further include a profit sharing model (PSM) including a PSM engine configured to interact with the MFM and the MFM engine to provide an equitable profit-sharing model to distribute downstream profits from the creative works or events related to the creative works. The system can also include a smart contracts system including a blockchain and associated devices as well as smart contracts implemented through the blockchain. The smart contracts system can be configured to execute agreements between end users of the system and implement tracking and ledgering aspects of the MFM and the PSM.

Additionally, the scripting language can be configured to manipulate, customize, and automate the facilities of a computer-implemented system configured to provide games and competitions. And, the games and competitions can include humans and artificial intelligence competing with each other as teams and against each other as competitors. Also, the scripting language can include a metalanguage designed for data collection, processing, and reporting, and wherein the scripting language provides an interface for users to capture and create database tokens, vocabulary, and phrase structure linguistic elements, allowing less technical users to enter and organize data and contexts into a database. The database can include a graph data structure configured to enhance searching and retrieval of information from the database.

These and other important aspects of the invention are described more fully in the detailed description below. The invention is not limited to the particular assemblies, apparatuses, methods, and systems disclosed herein. Other embodiments can be used and changes to the described embodiments can be made without departing from the scope of the claims that follow the detailed description.

### BRIEF DESCRIPTION OF THE DRAWINGS

The present disclosure will be understood more fully from the detailed description given below and from the accompanying drawings of various example embodiments of the disclosure.

FIG. 1 illustrates an example computer network to implement technologies disclosed herein, in accordance with some embodiments of the present disclosure.

FIG. 2 illustrates a block diagram of example aspects of an example computing system, in accordance with some embodiments of the present disclosure.

FIG. 3 illustrates example computer-executable instructions of the computing system of FIG. 2 that are configured to provide some of the steps of the methods described herein as well as some of the aspects of the systems described herein, in accordance with some embodiments of the present disclosure.

FIGS. 4 to 8 illustrate example methods of the technologies disclosed herein, in accordance with some embodiments of the present disclosure.

### DETAILED DESCRIPTION

The present disclosure will be understood more fully from the detailed description given below and from the accompanying drawings of various example embodiments of the disclosure.

Disclosed herein is a computing platform for providing enhanced interactivity with a chatbot system and other forms of artificial intelligence. The computing platform includes computer programming languages and systems thereof configured to interact with chatbots and chatbot systems. In some examples, the platform interacts, via at least one of the programming languages, with a large language model-based chatbot system—such as ChatGPT. In some examples, the platform includes the chatbot or the chatbot system. In some examples, the platform, via the programming language(s), interacts with a large language model-based chatbot system to input, record, organize, distribute, adapt, or perform creative works. The platform can also implement an MFM through at least one of the languages. Also, the platform can provide functions, via at least one of the languages, to interact with games and competitions where humans and artificial intelligence compete with and against each other.

For example, described herein are systems and methods for interacting with a chatbot system. In some examples, the systems and methods can interact with a large language model-based chatbot system, such as ChatGPT. In some examples, the technologies include a scripting language that can interact with a chatbot system or even a large language model-based chatbot system, such as ChatGPT. In some examples, a method includes a step for using a scripting language to interact with a chatbot system or a large language model-based chatbot system, such as ChatGPT.

Also, for example, described herein are systems and methods for interacting with a chatbot system to input, record, organize, distribute, adapt, or perform creative works. In some examples, the systems and methods can interact with a large language model-based chatbot system, such as ChatGPT, to input, record, organize, distribute, adapt, or perform creative works. In some examples, the technologies include a scripting language that can interact with a chatbot system or even a large language model-based chatbot system, such as ChatGPT, to input, record, organize, distribute, adapt, or perform creative works. In some examples, a method includes a step for using a scripting language to interact with a chatbot system or a large language model-based chatbot system, such as ChatGPT, to input, record, organize, distribute, adapt, or perform creative works.

Also, for example, described herein are systems and methods for overcoming some example technical problems associated with complex monetary transactions. The technologies described herein implement an MFM through a computing system to overcome such technical problems and other problems described herein or recognized by those skilled in the art. For instance, in some embodiments, a system can include an MFM including an MFM engine configured to run steps of the MFM to reduce complexity and inconsistencies in monetary transactions occurring through or related to a chatbot or the system. Also, any one of the programming languages described herein can further include functions of the MFM configured to facilitate the monetary transactions, and the steps of the MFM can include steps for running the functions of the MFM.

Also, for example, described herein are systems and methods for overcoming some example technical problems associated with games and competitions where humans and artificial intelligence compete with and against each other. The technologies described herein implement a converged human-AI team competition (CHATC) system and methods and sub-systems thereof to overcome such technical problems and other problems described herein or recognized by those skilled in the art. For example, any of the computer programming languages described herein can be configured to manipulate, customize, and automate the facilities of a computer-implemented system configured to provide games and competitions. And, the games and competitions can include humans and artificial intelligence competing with each other as teams and against each other as competitors.

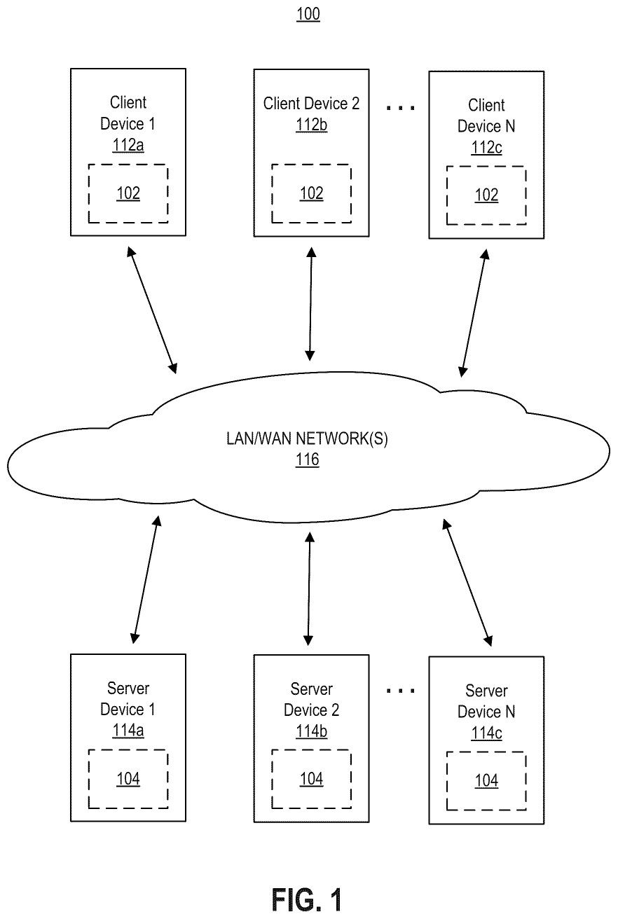

FIG. 1 illustrates an example computer network 100 to implement technologies disclosed herein (including a computing platform for providing enhanced interactivity with a chatbot system and other forms of artificial intelligence), in accordance with some embodiments of the present disclosure. Also, the computer network 100 can implement technologies disclosed in (1) U.S. Provisional Patent Application No. 63/564,921, filed on Mar. 13, 2024, and entitled “CONVERGED HUMAN-AI TEAM COMPETITION AND METHODS AND SYSTEMS THEREOF”, (2) U.S. Provisional Patent Application No. 63/609,607, filed on Dec. 13, 2023, and entitled “COMPUTING SYSTEM FOR A MONEY FLOW MODEL”, (3) U.S. Provisional Patent Application No. 63/545,461, filed on Oct. 24, 2023, and entitled “COMPUTING SYSTEM THAT INTERACTS WITH CHATBOT SYSTEMS TO RECORD, ORGANIZE, ENHANCE, DISTRIBUTE, ADAPT, AND/OR PERFORM CREATIVE WORKS”, and (4) U.S.

Provisional Patent Application No. 63/533,463, filed on Aug. 18, 2023, and entitled “COMPUTING SYSTEM THAT INTERACTS WITH CHATBOT SYSTEMS”, the entire disclosures of which applications are hereby incorporated herein by reference.

Some of the computing systems disclosed herein as well as the network 100 include a system frontend 102 and a system backend 104. The computer network 100 can implement any of the methods, operations, modules, engines, or other types of components of the systems disclosed herein, such as via the frontend 102 or the backend 104. The computer network 100 is shown including client devices (e.g., see client devices 112a, 112b, and 112c). As shown, the system frontend 102 can be hosted and executed on the client devices of the computer network 100. The computer network 100 is also shown including server devices (e.g., see server devices 114a, 114b, and 114c). As shown, the system backend 104 can be hosted and executed on the server devices of the computer network 100.

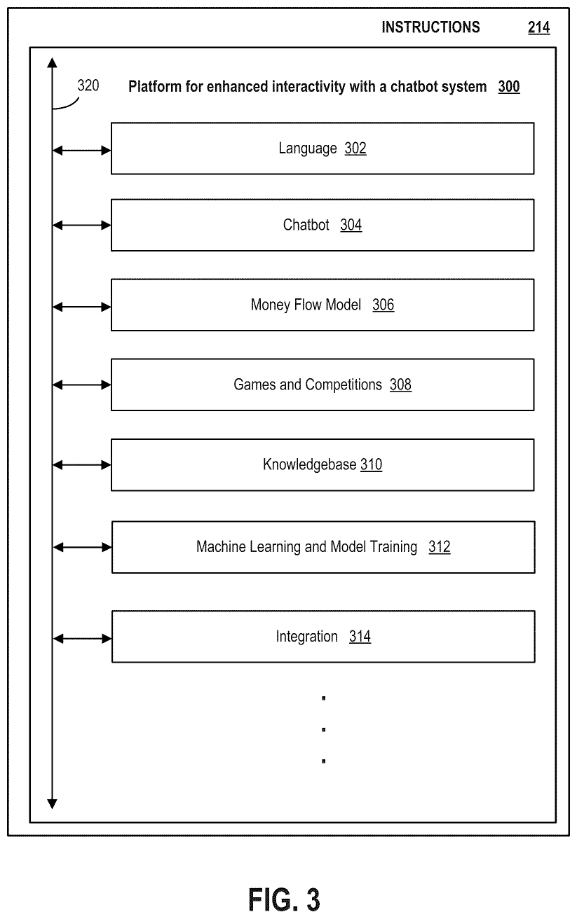

In some embodiments, the system frontend 102, or at least user interfaces of the front end, can be created and implemented through custom-created components or implemented through components of known libraries. In such embodiments and others, the system backend 104 can use or be configured for a cross-platform runtime environment that can run on various operating systems (such as Windows, Linux, Unix, macOS, etc.). For managing data used by the network 100, a relational database management system (RDBMS) or something as simple as a knowledgebase implemented through text files (such as comma-separated values (CSV) files) can be used that interacts with the system frontend 102 and the system backend 104, e.g., see knowledgebase sub-instructions 310 of system 200 shown in FIG. 3. In some embodiments, the RDBMS can be utilized via SQL and computer programming languages that can interact with SQL.

The frontend 102 or the backend 104 can be utilized via a user interface (UI). The UI or any other UI described herein can include a user interface device that includes the user interactive aspects of a computer system (such as a graphical user interface or GUI). A UI described herein includes one or more layers, including a human-machine interface (HMI) that interfaces machines with physical input hardware. In some embodiments, such a UI also includes a device that implements an HMI—also known as a human interface device (HID). In some examples, UI described herein include tactile UI (touch), visual UI (sight), auditory UI (sound), etc. In some embodiments, a graphical user interface (GUI), which is composed of at least a visual UI capable of displaying graphics, or any other type of UI presents information to a user of the network 100.

Also, the computer network 100 is shown including one or more LAN/WAN networks 116 which is shown communicatively coupling the server devices hosting the system backend 104 and the client devices hosting the system frontend 102. The LAN/WAN network(s) 116 can include one or more local area networks (LAN(s)) or one or more wide area networks (WAN(s)). The LAN/WAN network(s) 116 can include the Internet or any other type of interconnected communications network. The LAN/WAN network(s) 116 can also include a single computer network or a telecommunications network. More specifically, the LAN/WAN network(s) 116 can include a local area network (LAN) such as a private computer network that connects computers in small physical areas, a wide area network (WAN) to connect computers located in different geographical locations, or a metropolitan area network (MAN)—also known as a middle area network—to connect computers in a geographic area larger than that covered by a large LAN but smaller than the area covered by a WAN.

At least each shown component of the computer network 100 can be or include a computer system which can include memory that can include media. The media can include or be volatile memory components, non-volatile memory components, or a combination of such. In general, each of the computer systems can include a host system that uses the memory. For example, the host system can write data to the memory and read data from the memory. The host system can be a computing device such as a desktop computer, laptop computer, network server, mobile device, or such computing device that includes a memory and a processing device. The host system can include or be coupled to the memory so that the host system can read data from or write data to the memory. The host system can be coupled to the memory via a physical host interface. The physical host interface can provide an interface for passing control, address, data, and other signals between the memory and the host system.

As mentioned, with respect to some embodiments, disclosed herein are methods including a computer programming language interacting with a chatbot or a system providing a chatbot as well as a non-transitory computer-readable storage medium for carrying out technical operations of the methods. The non-transitory computer-readable storage medium has tangibly stored thereon, or tangibly encoded thereon, computer-readable instructions that when executed by one or more devices (e.g., one or more personal computers or servers) cause at least one processor to perform a method including a computer programming language interacting with a chatbot or a system providing a chatbot.

Also, with respect to some embodiments, a system is provided that includes a computer programming language configured to interact with a chatbot or a system providing a chatbot. And, with respect to some embodiments, a corresponding method is provided to be performed by at least one computing device. In some example embodiments, computer program code can be executed by at least one processor of one or more computing devices to implement functionality in accordance with at least some embodiments disclosed herein; and the computer program code being at least a part of or stored in a non-transitory computer-readable medium.

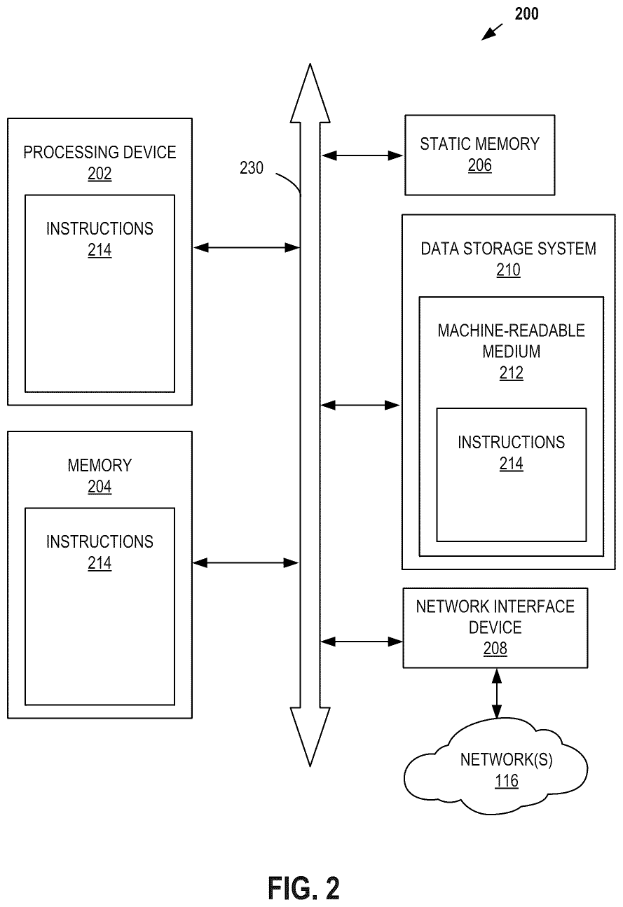

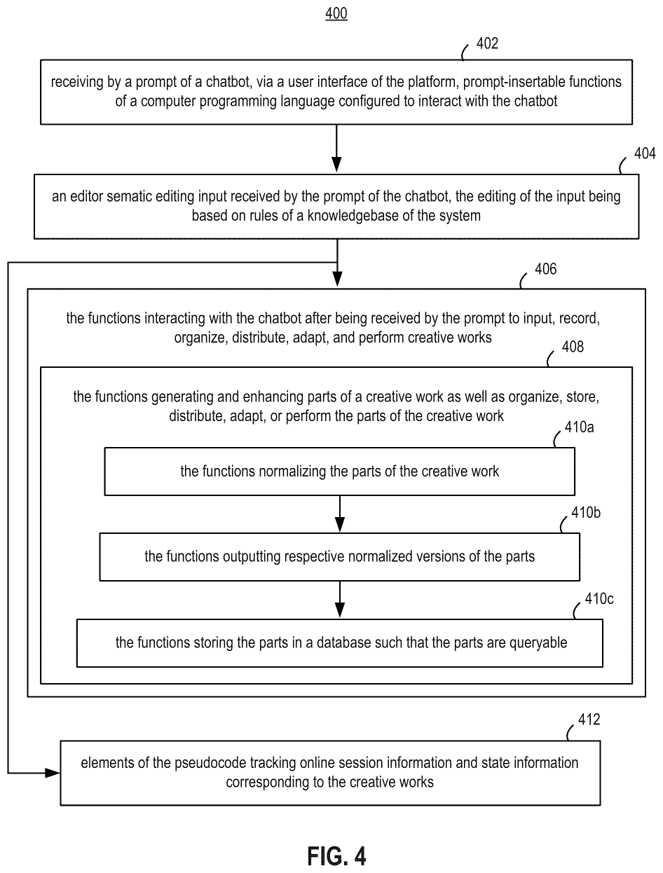

FIG. 2 illustrates a block diagram of example aspects of an example computing system 200, in accordance with some embodiments of the present disclosure. FIG. 2 illustrates parts of the computing system 200 within which a set of instructions, for causing a machine of the computing system 200 to perform any one or more of the methodologies discussed herein can be executed (such as any one or more of methods found in FIGS. 4 to 8). FIG. 2 also illustrates parts of the computing system 200 within which a set of instructions, for causing a machine of the computing system 200 to perform any one or more of the methodologies discussed in (1) U.S. Provisional Patent Application No. 63/564,921, filed on Mar. 13, 2024, and entitled “CONVERGED HUMAN-AI TEAM COMPETITION AND METHODS AND SYSTEMS THEREOF”, (2) U.S. Provisional Patent Application No. 63/609,607, filed on Dec. 13, 2023, and entitled “COMPUTING SYSTEM FOR A MONEY FLOW MODEL”, (3) U.S. Provisional Patent Application No. 63/545,461, filed on Oct. 24, 2023, and entitled “COMPUTING SYSTEM THAT INTERACTS WITH CHATBOT SYSTEMS TO RECORD, ORGANIZE, ENHANCE, DISTRIBUTE, ADAPT, AND/OR PERFORM CREATIVE WORKS”, and (4) U.S. Provisional Patent Application No. 63/533,463, filed on Aug. 18, 2023, and entitled “COMPUTING SYSTEM THAT INTERACTS WITH CHATBOT SYSTEMS”, the entire disclosures of which applications are hereby incorporated herein by reference. Also, the computing system 200 can include or be a part of a computing platform for providing enhanced interactivity with a chatbot system and other forms of artificial intelligence.

In some embodiments, the computing system 200 can correspond to a host system that includes, is coupled to, or utilizes memory or can be used to perform the operations of a controller (e.g., to execute an operating system to perform operations corresponding to any one of the client or server devices shown in FIG. 1). In alternative embodiments, the machine can be connected (e.g., networked) to other machines in a LAN, an intranet, an extranet, or the Internet. The machine can operate in the capacity of a server or a client machine in a client-server network environment, as a peer machine in a peer-to-peer (or distributed) network environment, or as a server or a client machine in a cloud computing infrastructure or environment. In some embodiments where a cloud computing infrastructure is used, the infrastructure utilizes an on-demand cloud computing platform and APIs. The machine can be a personal computer (PC), a tablet PC, a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computing system 200 includes a processing device 202, a main memory 204 (e.g., read-only memory (ROM), flash memory, dynamic random-access memory (DRAM), etc.), a static memory 206 (e.g., flash memory, static random-access memory (SRAM), etc.), and a data storage system 210, which communicate with each other via a bus 230. The processing device 202 represents one or more general-purpose processing devices such as a microprocessor, a central processing unit, or the like. More particularly, the processing device can be a microprocessor or a processor implementing other instruction sets, or processors implementing a combination of instruction sets. The processing device 202 can also be one or more special-purpose processing devices such as an application-specific integrated circuit (ASIC), a field programmable gate array (FPGA), a digital signal processor (DSP), a network processor, or the like. The processing device 202 is configured to execute instructions 214 for performing the operations discussed herein. The computing system 200 can further include a network interface device 208 to communicate over the LAN/WAN network(s) 116 of FIG. 1. The data storage system 210 can include a machine-readable storage medium 212 (also known as a computer-readable medium) on which is stored one or more sets of instructions 214 or software embodying any one or more of the methodologies or functions disclosed herein (such as any one or more of the methods or corresponding operations found in FIGS. 4 to 10). The instructions 214 can also reside, completely or at least partially, within the main memory 204 or within the processing device 202 during execution thereof by the computing system 200, the main memory 204 and the processing device 202 also constituting machine-readable storage media.

In some embodiments, the instructions 214 include instructions to implement functionality corresponding to the client devices and server devices shown in FIG. 1 (e.g., see system frontend 102 and system backend 104 shown in FIG. 1). While the machine-readable storage medium 212 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In some embodiments, the instructions 214 include instructions to implement functionality corresponding to artificial intelligence (AI) or machine learning disclosed herein (which in some embodiments can enhance the computerized decision making and determinations described herein). For the purposes of this disclosure, artificial intelligence includes any form of intelligence implemented by a machine, such as a computing system (e.g., see computing system 200). In some embodiments, AI disclosed herein includes machine learning. In some embodiments, AI disclosed herein includes search and mathematical optimization, formal logic, artificial neural networks (ANNs), methods based on statistics or probability, or any combination thereof. In some embodiments, machine learning disclosed herein includes supervised learning or unsupervised learning.

FIG. 3 illustrates example computer-executable instructions 214 and 300 that are configured to provide some of the operations and the steps of the methods described herein, in accordance with some embodiments of the present disclosure. The computer-executable instructions 214 and 300 can also be configured to provide some of the operations and the steps of the methods described in (1) U.S. Provisional Patent Application No. 63/564,921, filed on Mar. 13, 2024, and entitled “CONVERGED HUMAN-AI TEAM COMPETITION AND METHODS AND SYSTEMS THEREOF”, (2) U.S. Provisional Patent Application No. 63/609,607, filed on Dec. 13, 2023, and entitled “COMPUTING SYSTEM FOR A MONEY FLOW MODEL”, (3) U.S. Provisional Patent Application No. 63/545,461, filed on Oct. 24, 2023, and entitled “COMPUTING SYSTEM THAT INTERACTS WITH CHATBOT SYSTEMS TO RECORD, ORGANIZE, ENHANCE, DISTRIBUTE, ADAPT, AND/OR PERFORM CREATIVE WORKS”, and (4) U.S. Provisional Patent Application No. 63/533,463, filed on Aug. 18, 2023, and entitled “COMPUTING SYSTEM THAT INTERACTS WITH CHATBOT SYSTEMS”, the entire disclosures of which applications are hereby incorporated herein by reference.

As depicted, sub-instructions 300 are sub-instructions of instructions 214 and are configured to implement at least part of a computing platform for providing enhanced interactivity with a chatbot system and other forms of artificial intelligence. In other words, instructions 214 include sub-instructions 300 and also provide enhanced interactivity with a chatbot system and other forms of artificial intelligence. Also, as depicted, sub-instructions 302 to 314 are sub-instructions of sub-instructions 300. As a part of instructions 214, the processing device 202 is configured to execute sub-instructions 300 at its sub-instructions 302 to 314 for performing the operations discussed (e.g., see any one or more of the steps of methods 400 to 800 or operations found in FIGS. 4 to 8). The sub-instructions 300 can reside, completely or at least partially, within the main memory 204 or within the processing device 202 during execution thereof by the computing system 200, the main memory 204, and the processing device 202 also constituting machine-readable storage media. And, in some embodiments, the sub-instructions 300 include instructions to implement functionality corresponding to the client devices and server devices shown in FIG. 1 (e.g., see system frontend 102 and system backend 104 shown in FIG. 1). As shown, the sub-instructions 300 include sub-instructions 302 to 314, which can interact with each other through a communications bus 320. The bus 320 can be implemented via computer hardware or software.

Sub-instructions 300 are configured to implement at least part of a computing platform for providing enhanced interactivity with a chatbot system and other forms of artificial intelligence. The sub-instructions 300 include language sub-instructions 302, chatbot sub-instructions 304, money flow model sub-instructions 306, games and competitions sub-instructions 308, knowledgebase sub-instructions 310, machine learning and model training sub-instructions 312, and integration sub-instructions 314 for example.

The language sub-instructions 302 can be configured to provide or implement computer programming languages and systems thereof configured to interact with chatbots and chatbot systems. The chatbot sub-instructions 304 can be configured to provide or implement the chatbot or the chatbot system. The platform can interact, via at least one of the programming languages as well as sub-instructions 302, with a large language model-based chatbot system—such as ChatGPT. Also, the platform, via the programming language(s) as well as sub-instructions 302, can interact with a large language model-based chatbot system to input, record, organize, distribute, adapt, or perform creative works.

In some embodiments, the language sub-instructions 302 implement a system including a computer programming language configured to interact with a chatbot. In some cases, the computer programming language includes a scripting language. In some examples, the chatbot includes or is part of a chatbot system. In some cases, the chatbot includes or is part of a large language model-based chatbot system. In some examples, the large language model-based chatbot system includes ChatGPT. In some embodiments, the language sub-instructions 302 implement distributing or executing the system including the language. In some embodiments, the language sub-instructions 302 implement distributing or executing a computer programming language to interact with a chatbot.

In some examples, the language sub-instructions 302 are configured to provide or implement a computer programming language that is configured to interact with a chatbot. The chatbot can include or be a part of a large language model-based chatbot system. The computer programming language can include functions configured to interact with the chatbot, via a prompt of the chatbot, to input, record, organize, distribute, adapt, and perform creative works. And, the functions can also be configured to generate and enhance parts of a creative work as well as organize, store, distribute, adapt, or perform the parts of the creative work. The computer programming language can also include a scripting language configured to interact with the chatbot via the prompt. The scripting language can also be configured to generate and enhance parts of a creative work as well as organize, store, distribute, adapt, or perform the parts of the creative work.

Also, in some embodiments, the programming language includes functions configured to normalize the parts of the creative work. Also, the programming language can also include functions configured to output respective normalized versions of the parts and store the parts in a database such that the parts are queryable. In some cases, the normalization of the parts includes limiting, via filters of a weighting system, bias of a group or an individual inputting or recording the creative work. Also, the normalization of the parts can occur prior to organizing, storing, or distributing the parts.

Further, in some embodiments, the programming language includes prompt-insertable functions configured to be inserted into the prompt of the chatbot and configured to generate and enhance parts of creative work as well as organize, store, distribute, adapt, and perform the parts of the creative work. The prompt-insertable functions can include pseudocode and pseudocode parameters configured to modulate instructions performed via the prompt-insertable functions. The pseudocode can be received by the chatbot to configure the chatbot to perform a process that corresponds to the function of the pseudocode. And, the elements of the pseudocode can be configured to facilitate the recording of stories, conversations, and other expressions and to add additional functionality beyond verbal content to make the content organizable, interactive, persistent, and applicable to functionality related to storage in a database or a blockchain. Also, elements of the pseudocode can be configured to track online session information and state information corresponding to the creative works.

Also, in some embodiments, the language sub-instructions 302 are configured to provide or implement an editor configured to perform semantic editing of input received by the prompt of the chatbot, the editing of the input being based on rules of a knowledgebase of the system.

The money flow model sub-instructions 306 can be configured to provide or implement an MFM. The platform can also implement MFM through at least one of the languages and the corresponding instructions of sub-instructions 300. The MFM can include an MFM engine configured to run steps of the MFM to reduce complexity and inconsistencies in monetary transactions occurring through or related to the chatbot or the system. The programming language can further include functions of the MFM configured to facilitate the monetary transactions, and the steps of the MFM can include steps for running the functions of the MFM. Also, the steps of the MFM can include running a linguistic analysis on one or more inputs of the monetary transactions.

In some examples, money flow model sub-instructions 306 implement a computer-implemented method, including running one or more steps of an MFM to overcome at least one technical problem associated with complex monetary transactions. The method can also include using the output of the step(s) as input in re-running the step(s) of the MFM. The step(s) can include running a linguistic analysis. Also, the step(s) can include running a user-programmed script, programmed by a scripting language. The method can further include using machine learning to enhance the MFM. The method can also include using a chatbot input to input parameters and other types of information for the step(s). The method can also include distributing or executing the MFM to input, record, organize, distribute, adapt, and/or perform creative works. In some examples, money flow model sub-instructions 306 implement a system corresponding to the method.

The games and competitions sub-instructions 308 can be configured to provide or implement the functionality associated with games and competitions. Also, the platform can provide functions, via at least one of the languages as well as corresponding instructions of sub-instructions 300, to interact with games and competitions where humans and artificial intelligence compete with and against each other.

Also, depending on the embodiment, the games and competitions sub-instructions 308 or the money flow model sub-instructions 306 can provide or implement a code tracking system configured to generate codes (such as QR codes) and assign the codes to end users of the system to control access and participation in social events provided by the system. The code tracking system can also be configured to track, via the respective codes, the interests of the end users, interactions between the end users and system, and outcomes from the social events such as outcomes associated with the end users. And, the code tracking system can also be configured to use the tracked interests, interactions, and outcomes or a derivative thereof to perform further actions such as providing corresponding feedback to the end users and generating various metrics on the tracked interests, interactions, and outcomes.

In some cases, the end users include attendees of the social events. The social events can include games and competitions in which the attendees participate in the games and competitions. In such examples, the code tracking system can be configured to track, via the respective codes, the interests of the attendees, interactions between the attendees and the system, and outcomes from the games and competitions. And, the code tracking system can be configured to use the tracked interests, interactions, and outcomes or a derivative thereof to perform further actions such as providing corresponding feedback to the attendees and generating various metrics on the tracked interests, interactions, and outcomes.

Also, the games and competitions sub-instructions 308 can further include software systems that interface interactive physical areas that include a user interface device configured to provide the chatbot as well as additional user interface devices including components configured to sense attributes or actions of the end users or interact with the end users to accompany functionality of the chatbot. And, the additional user interface devices can include biometrics devices and environmental conditions sensors.

Also, in some embodiments, the money flow model sub-instructions 306 can be configured to provide or implement a profit sharing model (PSM) including a PSM engine configured to interact with the MFM and the MFM engine to provide an equitable profit-sharing model to distribute downstream profits from the creative works or events related to the creative works (such as the games and competitions at least partially implemented via sub-instructions 308). The sub-instructions 306 can also be configured to provide or implement a smart contracts system including a blockchain and associated devices as well as smart contracts implemented through the blockchain. The smart contracts system can be configured to execute agreements between end users of the system and implement tracking and ledgering aspects of the MFM and the PSM.

Also, the games and competitions sub-instructions 308 can at least partially implement (such as in combination with sub-instructions 302) a computer-implemented method that includes providing the basis and compiling of a scripting language useable to manipulate, customize, and automate the facilities of a computer-implemented system configured to provide games and competitions where humans and artificial intelligence compete with each other as teams and against each other as competitors. In some cases, the scripting language includes a metalanguage designed for data collection, processing, and reporting. And, in some examples, the scripting language provides an interface for users to capture and create database tokens, vocabulary, and phrase structure linguistic elements, allowing less technical users to enter and organize data and contexts into a graph database for efficient searching and retrieval. In some cases, the method includes providing a QR code tracking system. The code tracking system can be configured to assign QR codes to each attendee of the games and competitions to control access, log participation, and create personalized journeys through such events. And, the code tracking system can be configured to track an attendee's interests, interactions, and learning outcomes from the games and competitions, enabling customized experiences and valuable data insights. The method can also include providing AI interaction booths that include enclosed AI interaction pods. The attendees of the games and competitions can engage conversationally with AI for timed sessions, answering questions, taking assessments, and receiving personalized insights. The method can also include providing a foreground and background processing architecture that ensures smooth attendee flow by queueing QR code transactions to a database for later reconciliation by a separate accounting engine. And, the architecture can enhance real-time performance and data integrity for large-scale events of or related to the games and competitions.

In some examples, the method further includes providing an equitable profit-sharing model to distribute downstream profits from event-related content, including documentaries, with all attendees who contribute through their recorded interactions and experiences. And, the method can include using a blockchain technology or smart contracts to automate the profit-sharing model. Also, the method can include providing frictionless QR code-based transactions in a contained economic environment that includes attendee identification, merchant integration, inventory linking, behavior tracking, micro-lending, and multi-channel fulfillment. And, the method can include providing an apparatus for converged human-AI team competition that incorporates multi-modal biometrics, knowledge evaluations calibrated for difficulty, smart environmental sensors, and real-time scoring with explanations. Also, the method can include providing an immersive hybrid physical-virtual simulator network optimizing surgical education via haptic AI monitoring instrument handling and physiology with automated multi-point guidance on technique. Further, the method can include providing a genomic sequence database paired with behavioral analytics and AI modeling identifying connections between genetic variants, real-world function, ability thresholds, and environmental factors.

In some examples, the method can include providing a human-AI collaboration framework, wherein the collaboration framework is an overarching framework of the processes and features of the systems (such as the systems implemented via the instructions 214). And, the collaboration framework can define the relationships between human experts and AI in developing assistive tools and technologies which include the scripting language, the QR code system, the AI interaction booths, and other elements working together to create a human-AI collaboration environment. Also, the corresponding or related systems can include a human-AI collaboration framework as well as a scripting language, a QR code system, AI interaction booths, and other elements working together to create a human-AI collaboration environment. In such cases, the framework can provide the basis and compiling of the scripting language. And, the scripting language is useable to manipulate, customize, and automate the facilities of a computer-implemented system configured to provide games and competitions where humans and artificial intelligence compete with each other as teams and against each other as competitors. Also, in such examples, the scripting language can include a metalanguage designed for data collection, processing, and reporting. And, the language can also provide an interface for users to capture and create database tokens, vocabulary, and phrase structure linguistic elements, allowing less technical users to enter and organize data and contexts into a graph database for efficient searching and retrieval.

Further, the framework can provide a QR code tracking system, and the code tracking system can be configured to assign QR codes to each attendee of the games and competitions to control access, log participation, and create personalized journeys through such events. Also, the code tracking system is configured to track an attendee's interests, interactions, and learning outcomes from the games and competitions, enabling customized experiences and valuable data insights. And, the framework can provide the AI interaction booths that include enclosed AI interaction pods, and attendees of the games and competitions can engage conversationally with AI for timed sessions, answering questions, taking assessments, and receiving personalized insights.

Also, the framework can provide the foreground and background processing architecture that that ensures smooth attendee flow by queueing QR code transactions to a database for later reconciliation by a separate accounting engine, and the architecture can enhance real-time performance and data integrity for large-scale events of or related to the games and competitions. Also, the framework can provide an equitable profit-sharing model to distribute downstream profits from event-related content, including documentaries, with all attendees who contribute through their recorded interactions and experiences. The framework can also use a blockchain technology or smart contracts to automate the profit-sharing model.

Additionally, referring back to sub-instructions 302, the scripting language can be configured to manipulate, customize, and automate facilities of a computer-implemented system configured to provide games and competitions (such as games and competitions implemented or provided via sub-instructions 308). And, the games and competitions can include humans and artificial intelligence competing with each other as teams and against each other as competitors. Also, the scripting language can include a metalanguage designed for data collection, processing, and reporting, and wherein the scripting language provides an interface for users to capture and create database tokens, vocabulary, and phrase structure linguistic elements, allowing less technical users to enter and organize data and contexts into a database. The database can include a graph data structure configured to enhance searching and retrieval of information from the database.

Also shown in FIG. 3 are relational database management system sub-instructions (i.e., knowledgebase sub-instructions 310). The knowledgebase sub-instructions 310 can be configured to manage data and information received and processed by the computing system 200 as well as manage data and information received and processed by a computing system of the network 100, depending on the embodiment. The knowledgebase sub-instructions 310 can be configured to interact with the system frontend 102 and the system backend 104, for example. In some embodiments, an RDBMS, which can run according to knowledgebase sub-instructions 310, can be utilized via SQL and computer programming languages that can interact with SQL. The knowledgebase sub-instructions 310 can be configured to execute the SQL queries and computer programming languages that interact with SQL as well as related programs associated with data querying and storage described herein. In some cases, the knowledgebase sub-instructions 310 can be configured to store the outputs of a programming language interacting with a chatbot system, such as according to database queries or other types of instructions of a relational database management system.

Also shown in FIG. 3 are machine learning and model training sub-instructions 312. The machine learning and model training sub-instructions 312 can be configured to implement functionality corresponding to artificial intelligence (AI) or machine learning disclosed herein (which in some embodiments can enhance the computerized decision making and determinations described herein). For example, the sub-instructions 312, when executed, can be configured to enhance interactions between the languages and the chatbots and systems thereof.

Also shown in FIG. 3 are integration sub-instructions 314. In some embodiments, functionality of one or more of the aforesaid operations associated with sub-instructions 302 to 312 or functionality of one or more of the methods 400 to 800 can be integrated by the sub-instructions 314 with online applications, sites, or pages (such as web applications, sites, or pages). The integration performed via execution of sub-instructions 314 can include using one or more user interfaces and application programming interfaces configured to integrate the computing system and its various features and instructions with online applications, sites, or pages. In some embodiments, the integration can include or be a part of a computer program for web applications or sites such as a program coded in CSS, HTML, JavaScript, or another type of web programming language. The integration can also include a reference to libraries or other code directly from the source code of a website or application. Also, the integration can include instructions that do not need to be translated into machine code before it runs.

In some embodiments, the language sub-instructions 302 implement a system including a computer programming language configured to interact with a chatbot to input, record, organize, distribute, adapt, or perform creative works. The computer programming language can include a scripting language to input, record, organize, distribute, adapt, or perform creative works. The chatbot can include or is part of a chatbot system. The chatbot can include or is part of a large language model-based chatbot system. The large language model-based chatbot system can include ChatGPT. In some embodiments, the sub-instructions implement a computer-implemented method, including distributing or executing the system having the language to input, record, organize, distribute, adapt, or perform creative works. In some examples, the sub-instructions 302 implement a computer-implemented method, including distributing or executing a computer programming language to interact with a chatbot to input, record, organize, distribute, adapt, or perform creative works. The computer programming language can include a scripting language to input, record, organize, distribute, adapt, or perform creative works. In some examples, the computer programming language includes functions for generating and enhancing parts of a creative work as well as organizing, storing, distributing, adapting, or performing the parts of creative work. In some cases, the adapting or enhancing of the parts of the creative work including applying a normalization process to the parts of the creative work and a result of the normalization process includes outputting and storing a normalized version of the parts. In some examples, the normalization process includes limiting, via filters or a weighting system, the bias of sub-groups or an individual inputting or recording the creative work. In some examples, the normalization process occurs prior to an organizing, storing, or distributing process of the parts of creative work.

In some examples, the computer programming language includes functions that are insertable with the inputting of verbal information, and wherein in applicable embodiments the functions include the functions for generating and enhancing parts of the creative work as well as organizing, storing, distributing, adapting, or performing the parts of creative work. In some examples, the insertable functions are insertable verbally. Also, a component of the system can record voice input and derive verbal data from the recorded voice input. Further, the recorded voice input can include pseudo-code to emphasize or modulate one or more words in the recorded voice input. Also, the pseudo-code can be perceivable by the chatbot such that the chatbot performs a process that is corresponding to the function of the pseudo-code. Also, the insertion of the pseudo-code can allow for recorders of stories, conversations, and other expressions to add additional functionality beyond the verbal content to make the content organizable, interactive, persistent, and applicable to functionality related to storage, various data structures (such as blockchain systems). Furthermore, the insertion of the pseudo-code can allow for tracking session information as well as for tracking state information.

In some embodiments, a component of the system runs a background process for analyzing the input as well as performing semantic editing based on rules and a knowledge base of the system or the method. Also, a context of a session or a state can be attributable to the background process. Further, a component of the system can include a real-time searchable database with data that is retrievable and updatable in real time.

Also, a component of the system can include a logging mechanism configured to generate and maintain a log of actions occurring in the system. Also, the type of actions recorded by the logging mechanism (or logged) are selectable by a user of the system. Furthermore, a component of the system can include a reporting mechanism configured to generate and provide reports based on analyzed information of a log generated by the logging mechanism. And, a report generated by the reporting mechanism can include a status based on the log. Also, the report can prioritize information derived from the log. Further, the report or the log is immutable. And, the data of the report or the log can be stored via a blockchain. In some examples, the determined deltas between related information within the report or log are stored via the blockchain.

In some embodiments, a component of the system includes a module for generating and administering various user roles for the system. In some examples, one of the roles includes a guardian role for safeguarding users of the system who are minors or children. The guardian role can generate and administer guards against certain inputs and information of the system by detection of trigger words. And, the trigger words can be selectable by the guardian role.

FIGS. 4 to 8 illustrate example methods of the technologies disclosed herein, in accordance with some embodiments of the present disclosure. In some examples, one or more of the methods can be combined with another one or more of the methods disclosed herein or disclosed in (1) U.S. Provisional Patent Application No. 63/564,921, filed on Mar. 13, 2024, and entitled “CONVERGED HUMAN-AI TEAM COMPETITION AND METHODS AND SYSTEMS THEREOF”, (2) U.S. Provisional Patent Application No. 63/609,607, filed on Dec. 13, 2023, and entitled “COMPUTING SYSTEM FOR A MONEY FLOW MODEL”, (3) U.S. Provisional Patent Application No. 63/545,461, filed on Oct. 24, 2023, and entitled “COMPUTING SYSTEM THAT INTERACTS WITH CHATBOT SYSTEMS TO RECORD, ORGANIZE, ENHANCE, DISTRIBUTE, ADAPT, AND/OR PERFORM CREATIVE WORKS”, and (4) U.S. Provisional Patent Application No. 63/533,463, filed on Aug. 18, 2023, and entitled “COMPUTING SYSTEM THAT INTERACTS WITH CHATBOT SYSTEMS”, the entire disclosures of which applications are hereby incorporated herein by reference.

FIG. 4 shows a method 400, implemented by a computing system (such as the computing system 200 shown in FIG. 2), which can include or be a part of a computing platform for providing enhanced interactivity with a chatbot system and other forms of artificial intelligence. In some examples, method 400 can be combined with any one or more of the other methods disclosed herein. The method 400 includes, at step 402, receiving by a prompt of a chatbot, via a user interface of the platform, prompt-insertable functions of a computer programming language configured to interact with the chatbot. The method 400 also includes, at step 404, an editor sematic editing input received by the prompt of the chatbot, the editing of the input being based on rules of a knowledgebase of the system. The method 400 also includes, at step 406, the functions interacting with the chatbot after being received by the prompt to input, record, organize, distribute, adapt, and perform creative works. In some examples, the chatbot includes or is part of a large language model-based chatbot system. The method 400 also includes, at step 408, the functions generating and enhancing parts of a creative work as well as organize, store, distribute, adapt, or perform the parts of the creative work. In some examples, the computer programming language includes a scripting language configured to interact with the chatbot via the prompt and generate and enhance parts of a creative work as well as organize, store, distribute, adapt, or perform the parts of the creative work.

The method 400 also includes, at step 410a, the functions normalizing the parts of the creative work. In some examples, the normalization of the parts includes limiting, via filters of a weighting system, bias of a group or an individual inputting or recording the creative work. In some cases, the normalization of the parts occurs prior to organizing, storing, or distributing the parts. At step 410b, the method 400 continues with the functions outputting respective normalized versions of the parts. And, at step 410c, the method includes the functions storing the parts in a database such that the parts are queryable.

In some embodiments, the functions include pseudocode and pseudocode parameters configured to modulate instructions performed via the functions (such as step 406 or 408). In such examples, the pseudocode is received by the chatbot to configure the chatbot to perform a process that corresponds to the function of the pseudocode. And, elements of the pseudocode are configured to facilitate recording of stories, conversations, and other expressions and to add additional functionality beyond verbal content to make the content organizable, interactive, persistent, and applicable to functionality related to storage in a database or a blockchain. Also, the method 400 includes, at step 412, elements of the pseudocode tracking online session information and state information corresponding to the creative works. In some examples, the scripting language includes a metalanguage designed for data collection, processing, and reporting, and wherein the scripting language provides an interface for users to capture and create database tokens, vocabulary, and phrase structure linguistic elements, allowing less technical users to enter and organize data and contexts into a database. And, in some cases, the database includes a graph data structure configured to enhance searching and retrieval of information from the database.

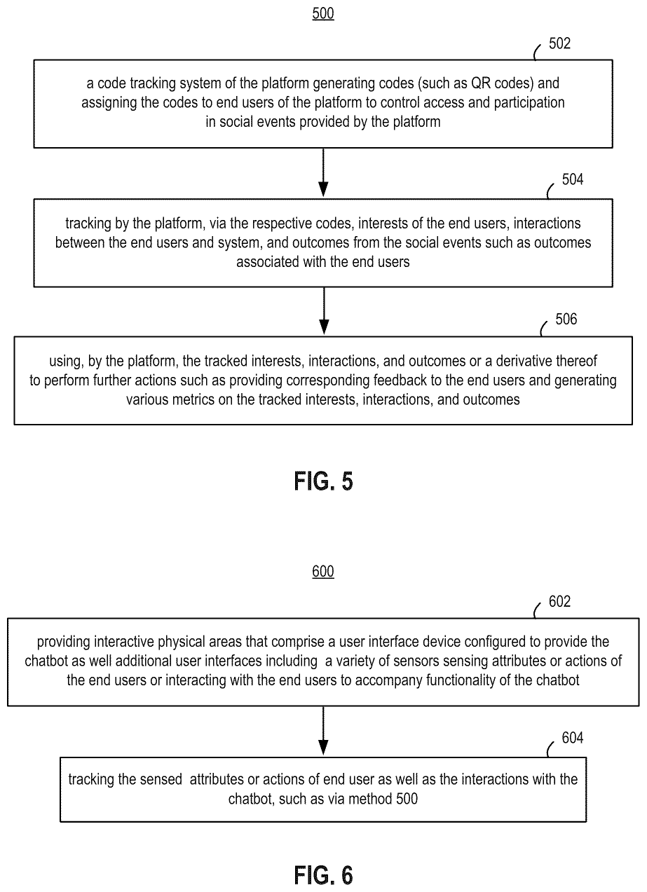

FIG. 5 shows a method 500, implemented by a computing system (such as the computing system 200 shown in FIG. 2), which can include or be a part of a computing platform for providing enhanced interactivity with a chatbot system and other forms of artificial intelligence. In some examples, method 500 can be combined with any one or more of the other methods disclosed herein. The method 500 includes, at step 502, a code tracking system of the platform generating codes (such as QR codes) and assigning the codes to end users of the platform to control access and participation in social events provided by the platform. The method 500 then continues with tracking by the platform, via the respective codes, interests of the end users, interactions between the end users and system, and outcomes from the social events such as outcomes associated with the end users (at step 504). And, the method 500 includes using, by the platform, the tracked interests, interactions, and outcomes or a derivative thereof to perform further actions such as providing corresponding feedback to the end users and generating various metrics on the tracked interests, interactions, and outcomes (at step 506). In some examples, the end users include attendees of the social events, the social events include games and competitions in which the attendees participate in the games and competitions, and the code tracking system is configured to track, via the respective codes, interests of the attendees, interactions between the attendees and the system, and outcomes from the games and competitions. Also, the code tracking system can be configured to use the tracked interests, interactions, and outcomes or a derivative thereof to perform further actions such as providing corresponding feedback to the attendees and generating various metrics on the tracked interests, interactions, and outcomes.

FIG. 6 shows a method 600, implemented partially by a computing system (such as the computing system 200 shown in FIG. 2), which can include or be a part of a computing platform for providing enhanced interactivity with a chatbot system and other forms of artificial intelligence.

In some examples, method 600 can be combined with any one or more of the other methods disclosed herein. Method 600 includes, at step 602, providing interactive physical areas that include a user interface device configured to provide the chatbot as well additional user interfaces including a variety of sensors sensing attributes or actions of the end users or interacting with the end users to accompany functionality of the chatbot. And, as shown, method 600 can include method 500 (at step 604), for tracking the sensed attributes or actions of the end user as well as the interactions with the chatbot. In some cases, the additional user interface devices include biometrics devices and environmental conditions sensors, for example.

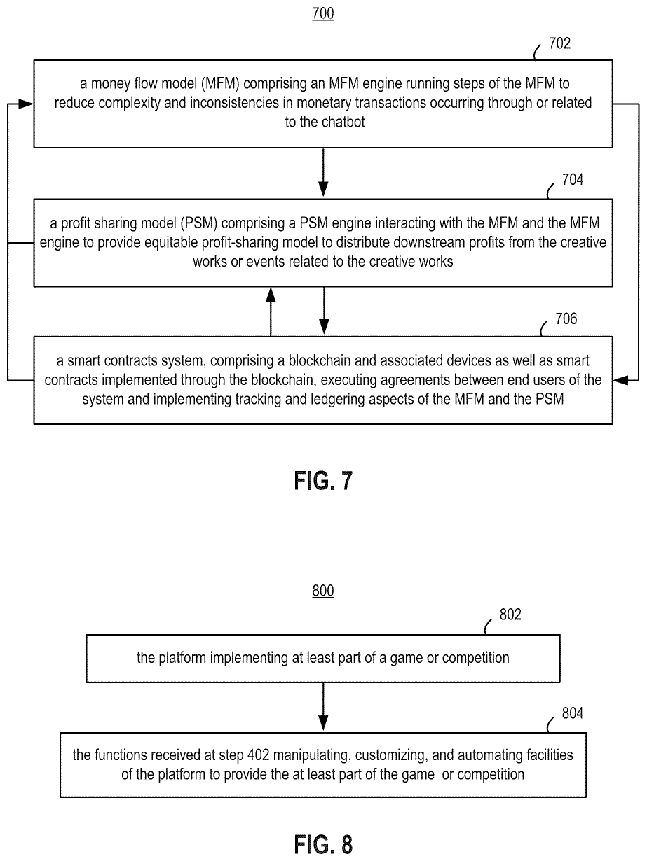

FIG. 7 shows a method 700, implemented by a computing system (such as the computing system 200 shown in FIG. 2), which can include or be a part of a computing platform for providing enhanced interactivity with a chatbot system and other forms of artificial intelligence. The method 700 includes an MFM, including an MFM engine running steps of the MFM to reduce complexity and inconsistencies in monetary transactions occurring through or related to the chatbot. In some examples, the programming language includes functions of the MFM configured to facilitate the monetary transactions, and the steps of the MFM include steps for running the functions of the MFM. And, in some cases, the steps of the MFM include running a linguistic analysis on one or more inputs of the monetary transactions. The method 700 also includes, at step 704, a PSM) including a PSM engine interacting with the MFM and the MFM engine to provide equitable profit-sharing model to distribute downstream profits from the creative works or events related to the creative works. Also, the method 700 includes a smart contracts system, including a blockchain and associated devices as well as smart contracts implemented through the blockchain, executing agreements between end users of the system and implementing tracking and ledgering aspects of the MFM and the PSM (at step 706).

FIG. 8 shows a method 800, implemented by a computing system (such as the computing system 200 shown in FIG. 2), which can include or be a part of a computing platform for providing enhanced interactivity with a chatbot system and other forms of artificial intelligence. The method 800 includes, at step 802, the platform implementing at least part of a game or competition. The method 800 also includes, at step 804, the functions received at step 402 manipulating, customizing, and automating facilities of the platform to provide the at least part of the game or competition. In some examples, the games and competitions include humans and artificial intelligence competing with each other as teams and against each other as competitors.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a predetermined result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and functionality presented herein are not inherently related to any particular computer or other apparatus. Various general-purpose systems can be used with programs in accordance with the teachings herein, or it can prove convenient to construct a more specialized apparatus to perform the methods disclosed herein. The structure for a variety of these systems will appear as set forth herein. In addition, the present disclosure is not described with reference to any particular programming language. It will be appreciated that a variety of programming languages can be used to implement the teachings of the disclosure as disclosed herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as read-only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a chatbot, wherein the chatbot comprises or is part of a large language model-based chatbot system; and
a computer programming language comprising functions configured to:
interact with the chatbot, via a prompt of the chatbot, to input, record, organize, distribute, adapt, and perform creative works; and
generate and enhance parts of a creative work as well as organize, store, distribute, adapt, or perform the parts of the creative work.

2. The system of claim 1, wherein the computer programming language comprises a scripting language configured to: interact with the chatbot via the prompt; and generate and enhance parts of a creative work as well as organize, store, distribute, adapt, or perform the parts of the creative work.

3. The system of claim 1, wherein the programming language comprises functions configured to:
normalize the parts of the creative work;
output respective normalized versions of the parts; and
store the parts in a database such that the parts are queryable.

4. The system of claim 3, wherein the normalization of the parts comprises limiting, via filters of a weighting system, bias of a group or an individual inputting or recording the creative work, and wherein the normalization of the parts occurs prior to organizing, storing, or distributing the parts.

5. The system of claim 1, wherein the programming language comprises prompt-insertable functions configured to be inserted into the prompt of the chatbot and configured to generate and enhance parts of creative work as well as organize, store, distribute, adapt, and perform the parts of the creative work.

6. The system of claim 5,
wherein the prompt-insertable functions comprise pseudocode and pseudocode parameters configured to modulate instructions performed via the prompt-insertable functions,
wherein the pseudocode is received by the chatbot to configure the chatbot to perform a process that corresponds to the function of the pseudocode, and
wherein elements of the pseudocode are configured to facilitate recording of stories, conversations, and other expressions and to add additional functionality beyond verbal content to make the content organizable, interactive, persistent, and applicable to functionality related to storage in a database or a blockchain.

7. The system of claim 6, wherein elements of the pseudocode are configured to track online session information and state information corresponding to the creative works.

8. The system of claim 1, further comprising an editor configured to perform sematic editing of input received by the prompt of the chatbot, the editing of the input being based on rules of a knowledgebase of the system.

9. The system of claim 1, further comprising a money flow model (MFM) comprising an MFM engine configured to run steps of the MFM to reduce complexity and inconsistencies in monetary transactions occurring through or related to the chatbot or the system, and
wherein the programming language comprises functions of the MFM configured to facilitate the monetary transactions, and wherein the steps of the MFM comprise steps for running the functions of the MFM.

10. The system of claim 9, wherein the steps of the MFM comprise running a linguistic analysis on one or more inputs of the monetary transactions.

11. The system of claim 1, further comprising a code tracking system, configured to:
generate codes (such as QR codes) and assign the codes to end users of the system to control access and participation in social events provided by the system;
track, via the respective codes, interests of the end users, interactions between the end users and system, and outcomes from the social events such as outcomes associated with the end users; and
use the tracked interests, interactions, and outcomes or a derivative thereof to perform further actions such as providing corresponding feedback to the end users and generating various metrics on the tracked interests, interactions, and outcomes.

12. The system of claim 11, wherein the end users comprise attendees of the social events, wherein the social events comprise games and competitions in which the attendees participate in the games and competitions, and wherein the code tracking system is configured to:
track, via the respective codes, interests of the attendees, interactions between the attendees and the system, and outcomes from the games and competitions; and
use the tracked interests, interactions, and outcomes or a derivative thereof to perform further actions such as providing corresponding feedback to the attendees and generating various metrics on the tracked interests, interactions, and outcomes.

13. The system of claim 11, further comprising interactive physical areas that comprise a user interface device configured to provide the chatbot as well as additional user interface devices comprising components configured to sense attributes or actions of the end users or interact with the end users to accompany functionality of the chatbot, and
wherein the additional user interface devices comprise biometrics devices and environmental conditions sensors.

14. The system of claim 9, further comprising a profit sharing model (PSM) comprising a PSM engine configured to interact with the MFM and the MFM engine to provide equitable profit-sharing model to distribute downstream profits from the creative works or events related to the creative works.

15. The system of claim 14, further comprising a smart contracts system comprising a blockchain and associated devices as well as smart contracts implemented through the blockchain, wherein the smart contracts system is configured to execute agreements between end users of the system and implement tracking and ledgering aspects of the MFM and the PSM.

16. The system of claim 2, wherein the scripting language is configured to manipulate, customize, and automate facilities of a computer-implemented system configured to provide games and competitions, and wherein the games and competitions include humans and artificial intelligence competing with each other as teams and against each other as competitors.

17. The system of claim 2, wherein the scripting language includes a metalanguage designed for data collection, processing, and reporting, and wherein the scripting language provides an interface for users to capture and create database tokens, vocabulary, and phrase structure linguistic elements, allowing less technical users to enter and organize data and contexts into a database.

18. The system of claim 17, wherein the database comprises a graph data structure configured to enhance searching and retrieval of information from the database.

19. A system, comprising:
a chatbot, wherein the chatbot comprises or is part of a large language model-based chatbot system; and
a computer programming language comprising functions configured to:
interact with the chatbot, via a prompt of the chatbot, to input, record, organize, distribute, adapt, and perform creative works; and
generate and enhance parts of a creative work as well as organize, store, distribute, adapt, or perform the parts of the creative work,
wherein the computer programming language comprises a scripting language configured to: interact with the chatbot via the prompt, and
wherein the scripting language includes a metalanguage.

20. A system, comprising:
a chatbot, wherein the chatbot comprises or is part of a large language model-based chatbot system;
a computer programming language comprising functions configured to:
interact with the chatbot, via a prompt of the chatbot, to input, record, organize, distribute, adapt, and perform creative works related to a game provided by the system; and
generate and enhance parts of a creative work related to the game as well as organize, store, distribute, adapt, or perform the parts of the creative work; and
a code tracking system, configured to:
generate codes (such as QR codes) and assign the codes to participants of the game to control access and participation in the game; and
track, via the codes, interests of the participants, interactions between the participants and system, and outcomes from the game.
